(19) United States
(12) Patent Application Publication
(10) Pub. No.: US 2013/0297406 A1
(43) Pub. Date: Nov. 7, 2013

(54) MATCHING CRITERIA SELECTION TO SCALE ONLINE EXPERIMENTS

(71) Applicants: Tarun Bhatia, Oak Park, CA (US); Ayman Farahat, San Francisco, CA (US)

(72) Inventors: Tarun Bhatia, Oak Park, CA (US); Ayman Farahat, San Francisco, CA (US)

(73) Assignee: Yahoo! Inc., Sunnyvale, CA (US)

(21) Appl. No.: 13/464,378

(22) Filed: May 4, 2012

(51) Int. Cl. G06Q 30/02

(52) U.S. Cl. 705/14.43; 705/14.41; 705/14.45

(57) ABSTRACT

A system and method for scaling causal lift is disclosed. Randomized experimental study data and observational data related to an advertising campaign is obtained. Response lift data from the randomized experimental study data and response lift data from the observational data are determined using regression discontinuity analysis. A model which includes an estimated response rate that corresponds to the randomized experimental study is created from the observational data using regression discontinuity analysis.

### BACKGROUND

Advertising exchanges are marketplaces that facilitate the buying and selling of online advertising. Ad exchanges are rapidly expanding both in terms of number of impressions and users and also in the availability of various tools such as targeting, bidding agents and optimization mechanisms. As new tools and algorithms get introduced it is important to evaluate the marginal contribution or causal impact of these tools and algorithms, i.e., the lift over the current baseline.

However, studying causal relationships requires expensive experimental studies. Techniques are needed to facilitate measurement and analysis of the causal impact these tools and algorithms have on online advertising campaigns.

### SUMMARY

Some embodiments of the invention provide a system and method for cost effectively determining causal relationships to facilitate efficient spending of advertising budgets. Traditionally, causal relation studies have required controlled experiments that randomize otherwise identical subjects into a control and treatment group. Subjects in the treatment group are exposed to treatment (ads), and their response is compared with those in the control group. The difference is then interpreted as a lift caused by the ad. The response may include clicking on an ad or purchasing a product or service advertised in the ad, etc.

However, this requires pre-processing and configuration steps, which are difficult to scale, for constructing efficient groups and setting their exposures to the ad serving system. Recognizing the experimental nature of the campaign is required up-front; otherwise there is very little insight that can be generated post-campaign. These requirements add friction in scaling experiments when seeking high quality insights for marketing. Relaxation of either of these constraints promises large scale experiments delivering adequate causal insights at scale.

Embodiments of the invention utilize regression discontinuity analysis, and as a result offer a cheaper alternative. Embodiments of the invention use results of randomized studies paired with regression discontinuity analysis around a predetermined threshold, to construct model(s) that may be used to bias-correct response rates (or lift) obtained from observational results. As a result, up front declaration of experimental intent is not needed as long as a tuned model is available. This advantageously allows campaigns to be analyzed post-mortem. Additionally, streaming data from online real-time phenomena can be analyzed, for instance from a campaign or a web publisher optimizing for content, without the need to declare experimental intent up front.

Regression discontinuity analysis elicits the causal effects of interventions by exploiting a given exogenous threshold determining assignment to treatment. By comparing observations lying closely on either side of the threshold, it is possible to estimate the local treatment effect in environments in which randomization was impractical.

It hinges on the similarity between users on either side of the threshold. In some embodiments, the threshold may also be the boundary separating users into those that barely qualified as in-target and were shown the ads (treatment group); versus those that barely missed, and were not targeted and not shown the ads (control group). The boundary may correspond to the threshold applied in the models that predict the propensity of a user to respond. This may also be employed in qualifying users to be considered in the target (or control) group. For example, a score that is used to predict the user's propensity to respond may be used to decide on a threshold and then users with a score greater than the threshold may be treated (e.g., targeted with ads). For instance, if the threshold for treatment is 0, users who have a positive score are treated and users who have a negative score are not treated. The users' tendency to respond may include, for example, clicking on an ad, making a purchase, etc.

Embodiments of the invention leverage the fact that right around the threshold, users who have a score of, for example, −0.01 (and who will not be treated) are very similar to users who have a score of 0.01 and are treated. These two groups serve as and control and test, respectively.

In some embodiments, for each of the scores or range of scores, the response lift (treated over untreated) may be computed at these scores. In some embodiments, ranges of scores, such as, 0.0 to 0.1, 0.1 to 0.2, etc. may be plotted as a curve, such that the x-axis may be the scores and the y-axis may be the lift.

If this is repeated for multiple experiments, a pattern (e.g., linear relationship) may emerge. Since a line is defined by two points, regression discontinuity analysis may be utilized to get the response lift at score 0 (which is one point). To get the second point, a particular score, for example, 0.3 may be selected. A subset of these users may be selected to not be shown ads (these users will be a control). Now, the response lift at score 0.3 may be computed by comparing the response of the test and control. Given the response lift at 0 and the lift at 0.3, a line may be constructed and used to predict the response lifts for other scores. Lift may be computed for additional points to improve accuracy and increase confidence.

Embodiments of the invention leverage multiple case studies, where access to both the randomized experiment data and observational data is available, to learn how to adjust the latter to match the former.

For a randomized experiment, data associated with the users (their propensity to respond scores), whether they were part of the control or treatment group, and their actual response will provide the true lift from the treatment. For the same data, regression discontinuity analysis may be utilized around the threshold that was used to select target users at the time of the campaign. The difference between the pseudo-control and treatment near the threshold provides the response lift from observations.

These two values may be compared to determine the correction required for that applicable threshold, and may be used to determine the level of correction to be applied to pure observational data thereafter. By repeating this process multiple experimental studies additional data points may be generated to build confidence.

In some embodiments, experimental data from a single study may be leveraged by constructing multiple sub-sets filtering the users by score on slightly tighter threshold values, and computing the measured lift within the resulting smaller control and treatment sub-groups. Once a structure is confirmed via a single or multiple randomized experiments to sufficient comfort, an appropriate number of regression discontinuity analyses may be executed and paired with randomized experiments.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

### DETAILED DESCRIPTION

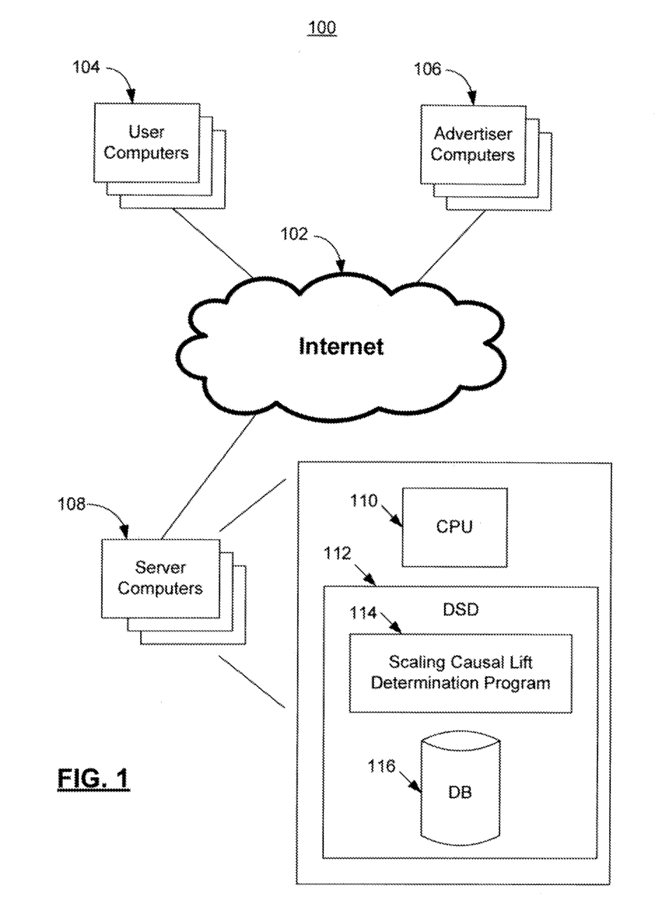

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as smart phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Scaling Causal Lift Determination Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Embodiments of the invention are directed to cost effectively determining causal relationships to facilitate efficient spending of advertising budgets. Traditionally, causal relation studies have required controlled experiments that randomize otherwise identical subjects into a control and treatment group. Subjects in the treatment group are exposed to treatment (ads), and their response is compared with those in the control group. The difference is then interpreted as a lift caused by the ad. The response may include clicking on an ad or purchasing a product or service advertised in the ad, etc.

However, this requires pre-processing and configuration steps, which are difficult to scale, for constructing efficient groups and setting their exposures to the ad serving system. Recognizing the experimental nature of the campaign is required up-front; otherwise there is very little insight that can be generated post-campaign. These requirements add friction in scaling experiments when seeking high quality insights for marketing. Relaxation of either of these constraints promises large scale experiments delivering adequate causal insights at scale.

One option is to run an advertising campaign normally without declaring any experimentation desire. The response rate of targeted users may then be interpreted naively as due to the ad. This response rate is often exaggerated. While this method is very cheap, the resulting bias requires correction.

At the other extreme is a full randomized experiment, which delivers high quality causal insights, but at a high cost. In addition, the control group in a randomized experiment comes at the cost of lost revenue because the control group includes users that could have been targeted, but weren't.

Embodiments of the invention utilize regression discontinuity analysis, and as a result offer a cheaper alternative. Embodiments of the invention use results of randomized studies paired with regression discontinuity analysis around a predetermined threshold, to construct model(s) that may be used to bias-correct response rates (or lift) obtained from observational results. As a result, up front declaration of experimental intent is not needed as long as a tuned model is available. This advantageously allows campaigns to be analyzed post-mortem. Additionally, streaming data from online real-time phenomena can be analyzed, for instance from a campaign or a web publisher optimizing for content, without the need to declare experimental intent up front.

Regression discontinuity analysis elicits the causal effects of interventions by exploiting a given exogenous threshold determining assignment to treatment. By comparing observations lying closely on either side of the threshold, it is possible to estimate the local treatment effect in environments in which randomization was impractical.

It hinges on the similarity between users on either side of the threshold. In some embodiments, the threshold may also be the boundary separating users into those that barely qualified as in-target and were shown the ads (treatment group); versus those that barely missed, and were not targeted and not shown the ads (control group). The boundary may correspond to the threshold applied in the models that predict the propensity of a user to respond. This may also be employed in qualifying users to be considered in the target (or control) group. For example, a score that is used to predict the user's propensity to respond may be used to decide on a threshold and then users with a score greater than the threshold may be treated (e.g., targeted with ads). For instance, if the threshold for treatment is 0, users who have a positive score are treated and users who have a negative score are not treated. The users' tendency to respond may include, for example, clicking on an ad, making a purchase, etc.

Embodiments of the invention leverage the fact that right around the threshold, users who have a score of, for example, −0.01 (and who will not be treated) are very similar to users who have a score of 0.01 and are treated. These two groups serve as and control and test, respectively.

In some embodiments, for each of the scores or range of scores, the response lift (treated over untreated) may be computed at these scores. In some embodiments, ranges of scores, such as, 0.0 to 0.1, 0.1 to 0.2, etc. may be plotted as a curve, such that the x-axis may be the scores and the y-axis may be the lift.

If this is repeated for multiple experiments, a pattern (e.g., linear relationship) may emerge. Since a line is defined by two points, regression discontinuity analysis may be utilized to get the response lift at score 0 (which is one point). To get the second point, a particular score, for example, 0.3 may be selected. A subset of these users may be selected to not be shown ads (these users will be a control). Now, the response lift at score 0.3 may be computed by comparing the response of the test and control. Given the response lift at 0 and the lift at 0.3, a line may be constructed and used to predict the response lifts for other scores. Lift may be computed for additional points to improve accuracy and increase confidence.

Embodiments of the invention leverage multiple case studies, where access to both the randomized experiment data and observational data is available, to learn how to adjust the latter to match the former.

For a randomized experiment, data associated with the users (their propensity to respond scores), whether they were part of the control or treatment group, and their actual response will provide the true lift from the treatment. For the same data, regression discontinuity analysis may be utilized around the threshold that was used to select target users at the time of the campaign. The difference between the pseudo-control and treatment near the threshold provides the response lift from observations.

These two values may be compared to determine the correction required for that applicable threshold, and may be used to determine the level of correction to be applied to pure observational data thereafter. By repeating this process multiple experimental studies additional data points may be generated to build confidence.

In some embodiments, experimental data from a single study may be leveraged by constructing multiple sub-sets filtering the users by score on slightly tighter threshold values, and computing the measured lift within the resulting smaller control and treatment sub-groups. Once a structure is confirmed via a single or multiple randomized experiments to sufficient comfort, an appropriate number of regression discontinuity analyses may be executed and paired with randomized experiments.

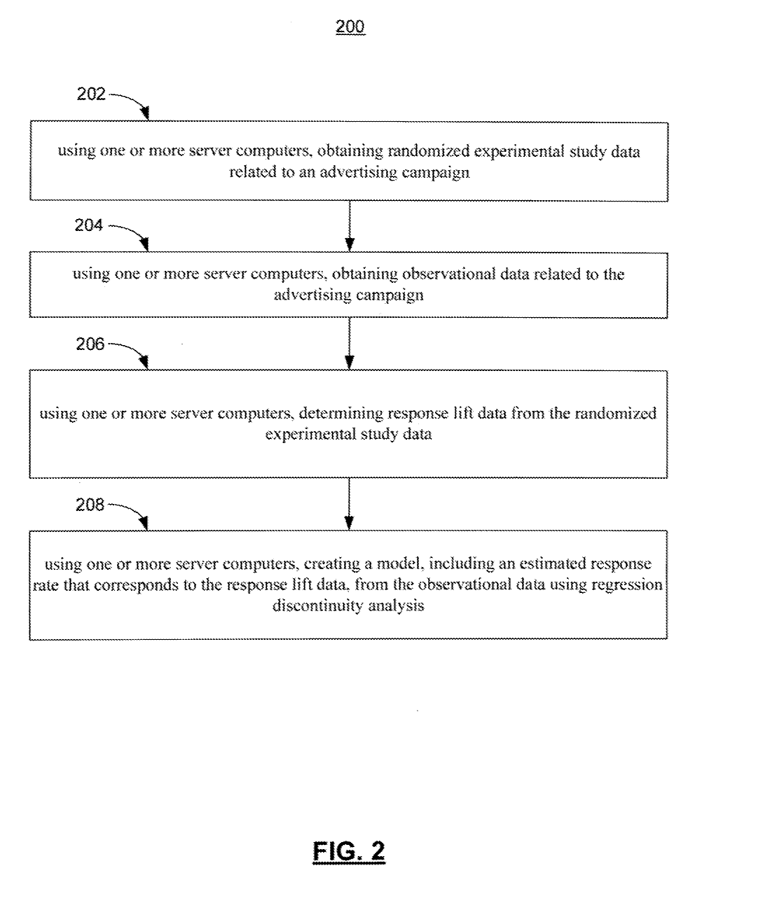

FIG. 2 is a flow diagram illustrating a method 200 according to one embodiment of the invention. At step 202, using one or more server computers, randomized experimental study data related to an advertising campaign may be obtained. At step 204, using one or more server computers, observational data related to the advertising campaign may be obtained.

At step 206, using one or more server computers, response lift data may be determined from the randomized experimental study data. At step 208, using one or more server computers, a model, including an estimated response rate that corresponds to the response lift data, may be created from the observational data using regression discontinuity analysis.

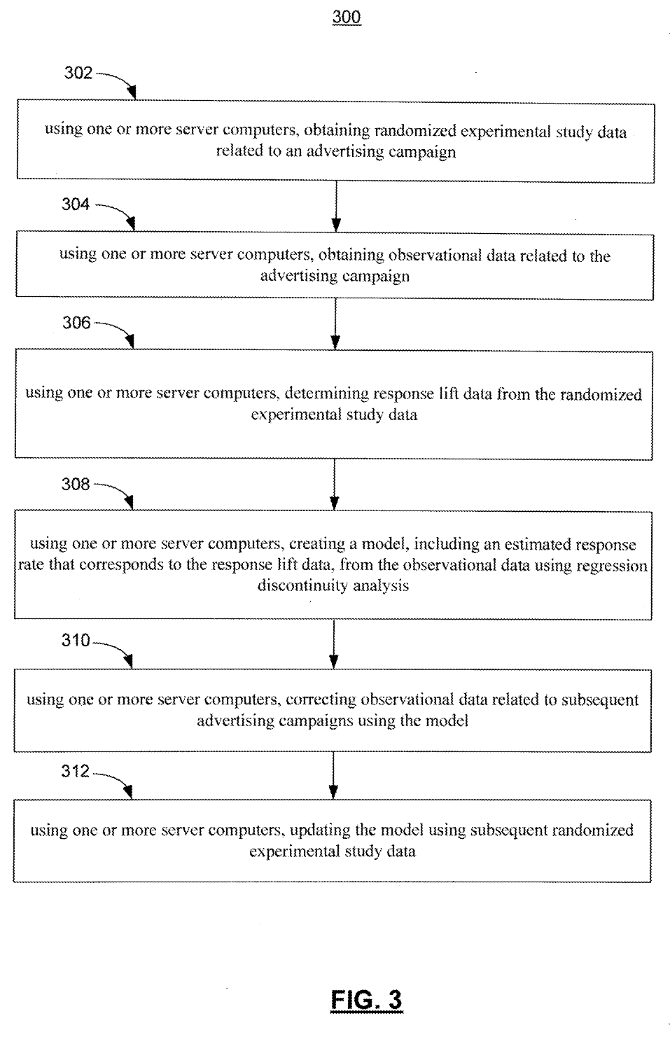

FIG. 3 is a flow diagram illustrating a method 300 according to one embodiment of the invention. At step 302, using one or more server computers, randomized experimental study data related to an advertising campaign may be obtained. At step 304, using one or more server computers, observational data related to the advertising campaign may be obtained.

At step 306, using one or more server computers, response lift data may be determined from the randomized experimental study data. At step 308, using one or more server computers, a model, including an estimated response rate that corresponds to the response lift data, may be created from the observational data using regression discontinuity analysis. At step 310, using one or more server computers, observational data related to subsequent advertising campaigns may be corrected using the model. At step 312, using one or more server computers, the model may be updated using subsequent randomized experimental study data.

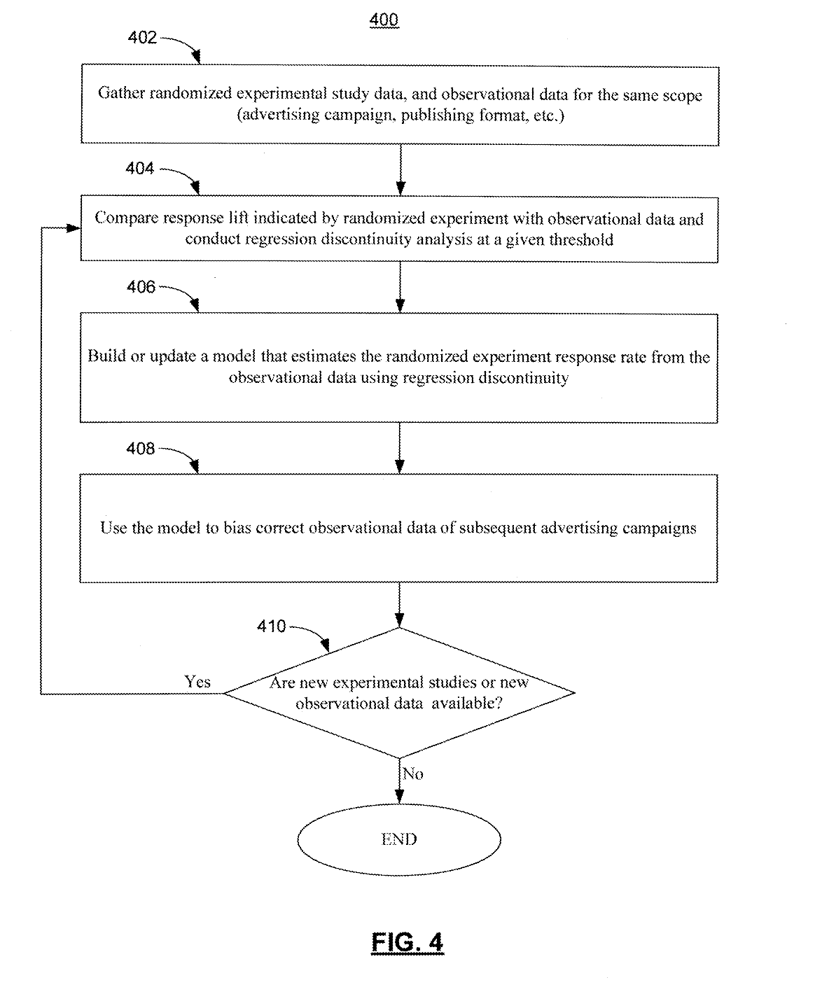

FIG. 4 is a flow diagram illustrating a method 400 according to one embodiment of the invention. At step 402, randomized experimental study data and observational data related to an advertising campaign may be obtained. At step 404, the response lift indicated by the randomized experiment may be compared with the observational data and regression discontinuity analysis may be utilized at a given threshold.

At step 406, a model that estimates the randomized experiment response rate from the observational data using regression discontinuity may be created or updated. At step 408, the model may be used to bias correct observational data of subsequent advertising campaigns. As new experimental studies become available, the model may be updated in step 406.

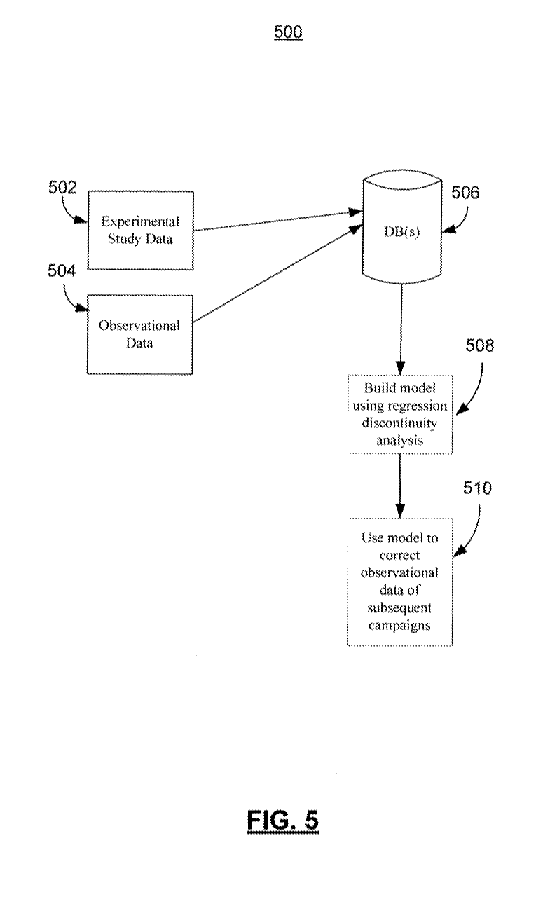

FIG. 5 is a block diagram 500 illustrating one embodiment of the invention. One or more data stores or databases 506 are depicted. Various types of information may be stored in the database 506. In particular, randomized experimental study data 502 and observational data 504 corresponding to one or more advertising campaigns are depicted. Randomized experimental study data 502 may include, for example, the number users in the study, the number of users in the control group, the number of users in the treatment or test group, the propensity to respond score(s) used to classify the users into the control or treatment groups, the type of ads shown to the users, the response rates, etc. Similar data may be included in observational data 504. The information stored in database 502 may be obtained, gathered, or generated in various ways from various sources.

As shown in block 508, a model may be constructed using regression discontinuity analysis. For example, response lift indicated by the randomized experiment may be compared with the observational data and regression discontinuity analysis may be utilized at a given threshold. The model may estimate a response rate for the observational data that corresponds to the response rate of the randomized experiment using regression discontinuity analysis. As depicted in block 510, the model may be used to correct observational data of subsequent advertising campaigns. The model may be updated as additional experimental studies become available.

While the invention is described with reference to the above drawings, the drawings are intended to be illustrative, and the invention contemplates other embodiments within the spirit of the invention.

1. A method comprising:
using one or more server computers, obtaining randomized experimental study data related to an advertising campaign;
using one or more server computers, obtaining observational data related to the advertising campaign;
using one or more server computers, determining response lift data from the randomized experimental study data; and
using one or more server computers, creating a model, including an estimated response rate that corresponds to the response lift data, from the observational data using regression discontinuity analysis.

2. The method of claim 1, further comprising:
using one or more server computers, correcting estimates of lift using observational data related to subsequent advertising campaigns using the model.

3. The method of claim 1, further comprising:
using one or more server computers, updating the model using subsequent randomized experimental study data.

4. The method of claim 1, wherein determining the response lift data comprises determining if a user clicked on an advertisement.

5. The method of claim 1, wherein determining the response lift data comprises determining if a user purchased an advertised product.

6. The method of claim 1, wherein the randomized experimental study data comprises data related to response rates of a control group and a test group.

7. The method of claim 6, wherein the test group includes users that were targeted with advertisements.

8. The method of claim 6, wherein the control group includes users that qualified to be targeted with advertisements but were not shown advertisements.

9. The method of claim 6, further comprising:
using one or more server computers, determining whether users belong to the control group or the test group based at least in part on a score assigned to each user, wherein the score represents each user's propensity to respond to an advertisement.

10. A system comprising:
one or more server computers coupled to a network; and
one or more databases coupled to the one or more server computers;
wherein the one or more server computers are for:
obtaining randomized experimental study data related to an advertising campaign;
obtaining observational data related to the advertising campaign;
determining response lift data from the randomized experimental study data; and
creating a model, including an estimated response rate that corresponds to the response lift data, from the observational data using regression discontinuity analysis.

11. The system of claim 10, wherein the one or more server computers are further configured for:
correcting observational data related to subsequent advertising campaigns using the model.

12. The system of claim 10, wherein the one or more server computers are further configured for:
updating the model using subsequent randomized experimental study data.

13. The system of claim 10, wherein determining the response lift data comprises determining if a user clicked on an advertisement.

14. The system of claim 10, wherein determining the response lift data comprises determining if a user purchased an advertised product.

15. The system of claim 10, wherein the randomized experimental study data comprises data related to response rates of a control group and a test group.

16. The system of claim 15, wherein the test group includes users that were targeted with advertisements.

17. The system of claim 15, wherein the control group includes users that qualified to be targeted with advertisements but were not shown advertisements.

18. The system of claim 15, further comprising:
using one or more server computers, determining whether users belong to the control group or the test group based at least in part on a score assigned to each user, wherein the score represents each user's propensity to respond to an advertisement.

19. The system of claim 15, wherein the first response lift data is calculated by subtracting a response rate of the control group from a response rate of the test group.

20. A computer readable medium or media containing instructions for executing a method comprising:
using one or more server computers, obtaining randomized experimental study data related to an advertising campaign;
using one or more server computers, obtaining observational data related to the advertising campaign;
using one or more server computers, determining response lift data from the randomized experimental study data;
using one or more server computers, creating a model, including an estimated response rate that corresponds to the response lift data, from the observational data using regression discontinuity analysis;
using one or more server computers, correcting observational data related to subsequent advertising campaigns using the model; and
using one or more server computers, updating the model using subsequent randomized experimental study data.
